(19) United States
(12) Patent Application Publication
(10) Pub. No.: US 2008/0250468 A1
(43) Pub. Date: Oct. 9, 2008

(54) System and method for scheduling presentation of future video event data

(75) Inventors: Marc Andrew Sullivan, Austin, TX (US); Javiar Arellano, Austin, TX (US); Donald Garofalo, Austin, TX (US); Paul Van Vleck, Austin, TX (US); Greg W. Edwards, Austin, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures. L.P., Reno, NV (US)

(21) Appl. No.: 11/784,198

(22) Filed: Apr. 5, 2007

(51) Int. Cl. H04N 7/173

(52) U.S. Cl. 725/115

(57) ABSTRACT

A method is disclosed for presenting video data comprising receiving at a first end user device, displayable video data for advertising a future video event; scanning the displayable video data for scheduling data associated with the future video event; and queuing the future video event for presenting data for the future video event based on the scheduling data. A system is disclosed for performing the method. A data structure is disclosed for containing data embedded in a computer readable medium for providing a functional and structural interrelationship between a processor, the data structure and data stored in the data structure.

### FIELD OF THE DISCLOSURE

The present disclosure generally relates to the field of scheduling of video event data presentation.

### BACKGROUND OF THE DISCLOSURE

Various systems are available for recording a television program. For example, video cassette recorders (VCRs) allow a user to record and playback television programs. The user of the VCR may watch the television program while it's being recorded and save the recorded program for future viewing. Alternatively, the VCR user may program the VCR to record a television program while the user is away or watching a different television program. The recorded program is then viewed at a later time.

Another type of video recording device is a digital video recorder (DVR). A DVR may also be referred to as a personal video recorder or a personal television server. A DVR records television programs on a disk drive (or other random access storage device) instead of a video tape. Typically the disk drive is not removable from the recorder and provides greater storage capacity than a conventional video tape. For example, a video tape may provide six hours of storage capacity while a DVR may provide twenty or more hours of storage capacity. The DVR can read from and write to any portion of the disk drive in a random manner. This capability allows the DVR to record one television program while simultaneously reading a recorded television program. Additionally, the DVR allows a user to begin viewing a recorded program while the program is still being recorded. For example, the viewer may program the DVR to record a particular television program that is one hour in length. Twenty minutes after the program has started, the viewer begins watching the recorded program from the beginning. While the viewer is watching the beginning of the program, the DVR continues recording the remainder of the program.

### BRIEF DESCRIPTION OF THE DRAWINGS

FIG. 1 depicts an illustrative embodiment of a system for scheduling presentation of future video event data in a particular illustrative embodiment;

FIG. 2 depicts a flow chart of functions performed in a particular method for scheduling presentation of future video event data in another particular illustrative embodiment;

FIG. 3 depicts a flow chart of functions performed in a particular method for scheduling presentation of future video event data in another particular illustrative embodiment;

FIG. 4 depicts a flow chart of functions performed in a particular method for scheduling presentation of future video event data in another particular illustrative embodiment;

FIG. 5 depicts a data structure embedded in a computer readable medium that is used by a processor and method for scheduling presentation of future video event data in another particular illustrative embodiment; and

FIG. 6 is an illustrative embodiment of a machine for performing functions disclosed in another illustrative embodiment for scheduling presentation of future video event data in another particular illustrative embodiment.

### DETAILED DESCRIPTION

In one particular illustrative embodiment, a method for scheduling presentation of video data is disclosed. The method includes but is not limited to receiving at a first end user device, displayable video data for advertising a future video event; scanning the displayable video data for scheduling data associated with the future video event; and queuing the future video event for presenting data for the future video event based on the scheduling data. In another particular illustrative embodiment of the method the scheduling data are data selected from the group consisting of video, audio, image and text data. In another particular illustrative embodiment of the method the scheduling data further comprises scheduling marker data associated with preloaded scheduling data in a database.

In another particular illustrative embodiment of the method the scheduling marker data are received at the first end user device prior to receiving the displayable video data. In another particular illustrative embodiment of the method the scheduling marker data further comprise key word data selected from the group consisting of audio, video, text and image data. In another particular illustrative embodiment of the method presenting further includes an act selected from the group consisting of displaying and sounding future video event data on a second end user device, and the first end user device and the second end user device are different end user devices associated with an end user.

In another particular illustrative embodiment, the method further includes receiving notification data at a second end user device indicating pending presentation the of the future video event data, wherein the first end user device and the second end user device are different devices selected from the group consisting of a set top box, cell phone, personal data assistant, web tablet, portable internet protocol device, personal computer and lap top computer. In another particular illustrative embodiment, the method further includes presenting future video event data at a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

In another particular illustrative embodiment, in the method the end user profile data indicates a second end user device based on a factor selected from the group consisting of end user location data, end user historical presenting history data, end user device selection data and end user device storage capacity data. In another particular illustrative embodiment, in the method the scheduling marker data is received by a first selected end user device, wherein the first selected end user device is selected based on end user profile data indicating an end user preference for the future video event. In another particular illustrative embodiment, the method further includes selecting a second end user device for receipt and presentation of future video event data.

In another particular illustrative embodiment, a method for sending future video event data to an end user device is disclosed, the method including but not limited to sending from a internet protocol television (IPTV) video server to a first end user device, displayable video data for advertising a future video event, wherein the displayable video data includes scheduling data for the future video event for presentation of future video event data, wherein the scheduling data further comprises scheduling marker data associated with the scheduling data in a data base. In another particular illustrative embodiment of the method, the method further includes the scheduling marker data are sent to the first end user device prior to sending the displayable video data based on end user profile data. In another particular illustrative embodiment of the method, the method further includes sending notification data to a second end user device indicating pending receipt and presentation of future video event data, wherein the first end user device and the second end user device are different devices selected from the group consisting of a set top box, cell phone, personal data assistant, web tablet, portable internet protocol device, personal computer and lap top computer.

In another particular illustrative embodiment of the method, the method further includes sending future video event data to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

In another particular illustrative embodiment a computer readable medium containing a computer program useful for presenting video data, is disclosed, the computer program including but not limited to instructions to receive at a first end user device, displayable video data advertising a future video event; instructions to scan the displayable video data for scheduling data for the future video event; and instructions to queue the future video event for presentation based on the scheduling data. In another particular illustrative embodiment a computer readable medium containing a computer program useful for presenting video data, is disclosed, the computer program including but not limited to instructions to send from an internet protocol television (IPTV) video server to a first end user device, displayable video data advertising a future video event, wherein the displayable video data includes scheduling data for the future video event for presenting data for the future video event wherein the scheduling data further comprises scheduling marker data associated with the scheduling data in a data base. In another particular illustrative embodiment of the computer readable medium, in the computer program the scheduling marker data are sent to the first end user device prior to sending the displayable video data based on an end user profile.

In another particular illustrative embodiment a system is disclosed for scheduling presentation of future video event data, the system including but not limited to a first end user device processor in data communication with a memory, the first end user device processor further comprising a first interface for receiving at a first end user device, displayable video data advertising a future video event; and a computer program embedded in the memory, the computer program comprising instructions to scan the displayable video data for scheduling future video event data and instructions to queue the future video event for presentation based on the scheduling data. In another particular illustrative embodiment the system further includes but is not limited to a second interface for receiving scheduling marker data associated with the scheduling data in a data base, wherein the scheduling marker data further comprise key word data selected from the group consisting of audio, video, text and image data.

In another particular illustrative embodiment the system further includes but is not limited to a second end user device processor in data communication with a memory, the second end user device processor further includes but is not limited to a third interface for receiving notification data for the future video event. In another particular illustrative embodiment the system further includes but is not limited to a second end user device processor in data communication with a memory, the second end user device processor including a fourth interface for receiving data for the future video event. In another particular illustrative embodiment a system for sending video data to an end user device is disclosed, the system including but not limited to a processor at a video server in data communication with a memory, the processor further including but not limited to a first interface for sending from the video server to a first end user device, displayable video data advertising a future video event, wherein the displayable video data includes scheduling data for the future video event for presentation of data for the future video event, wherein the scheduling data further comprises scheduling marker data associated with the scheduling data in a data base. In a particular embodiment, the displayable data includes but is not limited to video and audio data in the data stream for presentation (display and sounding) on an end user device and does not include metadata inserted into a video data stream such as meta data inserted into a motion picture expert group (MPEG) data stream.

In another particular illustrative embodiment of the system the scheduling marker data are sent as a scheduling marker data queue of to the first end user device prior to sending the displayable video data based on an end user profile. In another particular embodiment, the scheduling marker data queue can be sent as metadata in an MPEG video data stream. In another particular illustrative embodiment of the system further includes a second interface for sending notification data to a second end user device indicating pending data for the future video event, wherein the first end user device and the second end user device are different devices selected from the group consisting of a set top box, cell phone, personal data assistant, web tablet, portable internet protocol device, personal computer and lap top computer.

In another particular illustrative embodiment of the system, the system further includes a third interface for sending data for the future video event to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

In another particular illustrative embodiment a computer readable medium is disclosed having a data structure embedded therein for storing data, the data structure further including a first field for containing data indicating displayable scheduling marker data for a future video event selected based on end user profile data. In another particular illustrative embodiment of the medium the data structure further includes but is not limited to a second field for containing data indicating an end user device presentation selection for selecting an end user device for receiving data for the future video event (also referred to herein throughout as future video event data). In another particular illustrative embodiment of the medium the data structure further includes but is not limited to a third field for containing data indicating an end user device notification selection for selecting an end user device for receiving notification data regarding scheduling of the future video event. In another particular illustrative embodiment of the medium the data structure further includes but is not limited a fourth field for containing data indicating an end user device storage capacity for an end user device for determining whether the end user device can store data for the future video event.

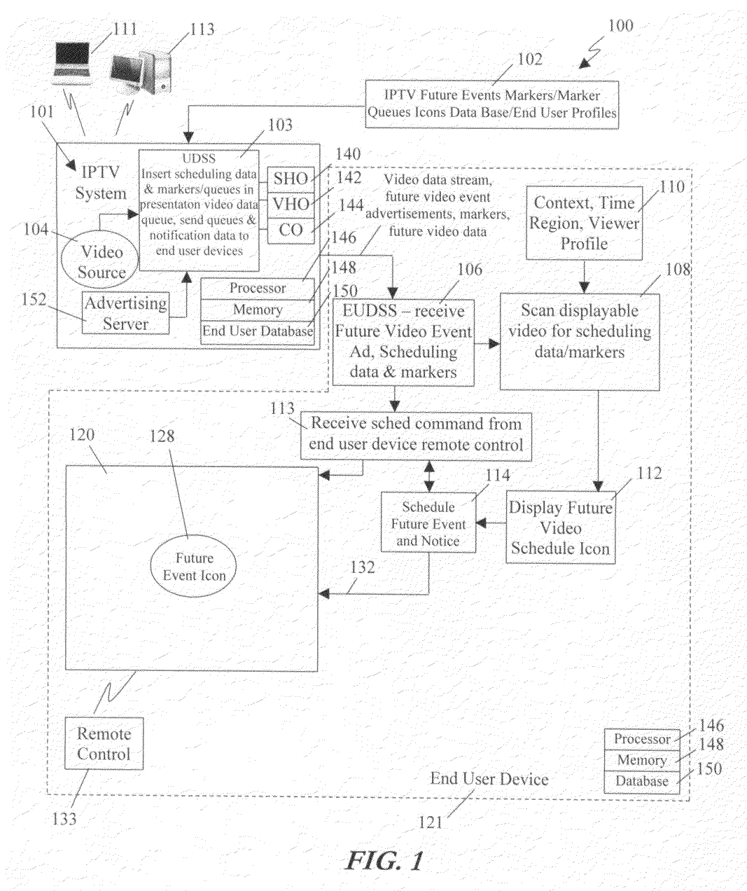

Turning now to FIG. 1, FIG. 1 depicts an illustrative embodiment of a television signal delivery system 100, including but not limited to an internet protocol television (IPTV) system 101 and an end user device 121 for receiving advertising data for future video events and data for the future vide events (future video event data) including notification data apprising an end user that a scheduled future video event is pending, giving a date and time for the pending scheduled future video event. The IPTV system includes a hierarchically arranged network of IPTV servers that communicate over a digital communication network, and form a digital IPTV network. The IPTV network streams internet protocol (IP) video data from a super head end (SHO) server 140, video head end (VHO) server 142, or central office (CO) server 144 to an end user device. The IPTV system also includes wireless routers or other wireless devices that send wireless IP data to remote mobile devices 111 and 113 associated with an end user. Additional wireless networks can be utilized to facilitate wireless communication with the end user devices.

The IPTV system communicates wireless IP data to the mobile devices either directly or through other networks in data communication with the IPTV system. In an illustrative embodiment, the IPTV system includes IP data communication services for performing voice over internet protocol (VOIP) and internet service provider data services to end user devices including but not limited to end user device 121, 111 and 113. The ITPV system communicates with end user devices over data communication networks such as the internet or other available digital communication networks.

The IPTV system 101 includes but is not limited to an upstream data sensing system (UDSS) 103. The UDSS inserts future video event scheduling data into displayable video data. Displayable video data includes that data (video, audio, text and video data) in the vide data stream that is presented visually or audibly to an end user, as opposed to metadata that is not presented visually or audibly to an end user. The displayable image, text, video and audio scheduling data are included in a displayable portion of the video data stream from video server 104.

The end user device 121 includes but is not limited to an end user data sensing system (EUDSS) 106. Thus, the IPTV system comprises a hierarchical network of servers (SHO, VHO, CO) that hierarchically distribute a video data stream. The IPTV video data stream can be an MPEG video data stream that includes displayable video and audio data and non displayable video metadata. The metadata is not displayable in the sense that it is not typically displayed or sounded, but is used to describe and provide auxiliary data to aid in the display of the displayable video data. The hierarchical IPTV network distributes the video data hierarchically to smaller geographic regions and associated servers (SHO to VHO to CO respectively) and finally to an end user devices 121, 111 and 113.

The displayable video data includes audio, text video and images that are presented to an end user, that is, audio data is sounded and text, images and video data are displayed and/or sounded on an end user presentation device 120. The end user presentation device 120 includes but is not limited to a display and sound reproduction system, such as a loudspeaker or piezoelectric device. The SHO server delivers national video data (including image, video, text and audio data) content in the form of a television signal (e.g., an IPTV digital video data stream) to regional VHO server, which redistributes the video data stream to sub regional CO servers. Each SHO, VHO, CO and end user device 121 contains an advertising/video data server having a processor 146, computer readable medium (media) collectively referred to as memory 148 and database 150. The UDSS 103 and EUDSS 106 sense scheduling data in the video data stream television signal having different data types. The UDSS can be associated with an SHO, VHO or CO for selection and insertion of scheduling data and scheduling marker data for distribution to particular end user devices.

In one particular illustrative embodiment, the EUDSS and UDSS compares the video data stream that makes up the television signal data to a scheduling data queue to sense the scheduling data in the television signal. In a particular illustrative embodiment a UDSS then marks the scheduling data with scheduling marker data for sensing of the scheduling marker data at a down stream EUDSS. In another particular illustrative embodiment, the EUDSS senses scheduling markers data and associates the scheduling marker data with scheduling data in a database. In another particular illustrative embodiment, the UDSS associated with an SHO, VHO or CO selects end users to be apprised of future video events that match the selected end users' interests and viewing habits based on the end users' profile data. Each end user device can receive a separate scheduling marker data queue so that individual end user can receive a different scheduling marker data queue and thus be apprised of different future video events for scheduling. Thus, an end user having an interest in sports based on viewing history, prior scheduled video events, purchasing history and phone call history as indicated in the end user's profile, will be sent scheduling data or scheduling marker data queue for future video sporting events. Another end user having an interest in politics based on viewing history, prior scheduled video events, purchasing history and phone call history as indicated in the end user's profile, will be sent scheduling data or scheduling marker data queue for future video political events. A future video event scheduling icon is displayed at a recipient end user device when the recipient end user device senses a member of its received scheduling marker data queue that appears in a received video data stream.

Thus, in a particular embodiment, every end user is not apprised via a future video scheduling icon, of every schedulable future video event. For example, if five future video events appear in the video data stream and are schedulable, a first end user device may receive a schedule markers data queue containing scheduling data markers for future video events one, three and five and a second end user device may receive a schedule markers data queue containing scheduling data markers for future video events two and four. When the first end user device receives and senses a scheduling data marker for video event one, three or five, the first end user device senses it as a member of its scheduling data marker queue and displays a future video scheduling event icon and prepare to receive a schedule event input from the first end user device via an associated remote control. The first end user device ignores scheduling data marker for video events two and four because these markers do not appear in the received scheduling data marker queue for the first end user device. Similarly, when the second end user device receives a scheduling data marker for video events two or four, the second end user device senses it as a member of its scheduling data marker queue and displays a future video scheduling event icon and prepare to receive a schedule event input from the second end user device via an associated remote control. The second end user device ignores scheduling data marker for video events one, three and five because these markers do not appear in the received scheduling data marker queue for the second end user device.

A video source 104 provides the video data stream, which originates in the IPTV system. The future video event markers data and scheduling marker data queues and scheduling data are provided by the advertising server 152 and/or IPTV database 102. End user profiles data stored in the data base 102 are used by advertisers to decide on which end users will receive a marker for a particular future video event.

The displayable video data includes future video event scheduling data and scheduling markers data that can be sensed in the television signal or IPTV video data stream. The future video event scheduling data and scheduling markers data may be of different data types, including but not limited to video data, image data, text data and audio data. The scheduling data can be audio key words such as “next Tuesday on Channel 9 at 10 PM” or text, image or video key words such as “Tuesday, Channel 9 at 10 PM”. The EUDSS 106 senses or recognizes scheduling data including but not limited to video data, image data, text data and audio data in the television signal or video data stream to generate keywords from the combination of the images, audio and text data sensed in the incoming video signal. In a particular illustrative embodiment, the incoming television signal is a digital video data stream, delivered from an IPTV system network of servers. In another particular illustrative embodiment, the television signal is a digital television video signal delivered over a broadcast cable system. In another particular illustrative embodiment, the television signal is an analog television signal delivered over a radio frequency antenna. In another particular illustrative embodiment, generic data including but not limited to video data, image data, text data, and audio data are sensed in the video data stream television signal by the EUDSS in the IPTV system.

The scheduling markers queue data can be inserted into the television signal, e.g., using metadata in an MPEG video data stream or sent separately to an end user device. The scheduling marker data can be sensed by a EUDSS 106 at an end user device 121 such as a set top box. In an illustrative embodiment, the marker data is inserted into the display video data. In another particular illustrative embodiment, the marker data is inserted into the metadata for the video data stream. The marker data may be associated with scheduling data in the data base or may be an indicator for the EUDSS to look for scheduling data of a particular data type in the following video data within a particular time frame, for example, 10 seconds.

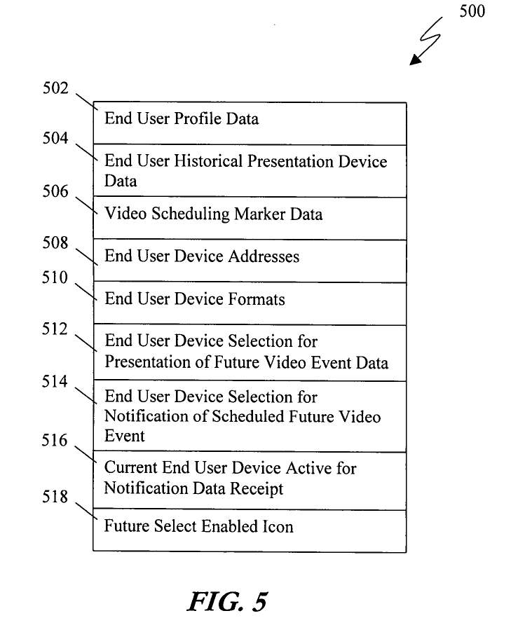

In another particular embodiment, the end user devices 111 and 113 are a mobile Internet protocol (IP) devices including but not limited to a cell phone, personal data assistant or a web tablet. The scheduling marker data is compared to scheduling data including video, audio, image and text data in the incoming television signal. In another particular illustrative embodiment, the scheduling data is carried in metadata for the video data stream. Sensed scheduling marker data is matched with scheduling data in a database 150 at the end user device. End users can select which device 121, 111 or 113 at which the end user wishes to receive notification of pending delivery of future video event data and the data for the future video event upon occurrence of a schedule future video event time. Once a future video event marker from a particular end user's marker queue is sensed in a video presentation data stream, a future video event icon 128 is displayed on the end user presentation system 120 indicating to the particular end user associated with the end user marker queue that the future video event can be scheduled with notification and presentation at a selected end user device. The end user device selected for receipt of notifications data and future video event data can be selected by the end user or selected by the method and apparatus based on an end user's current location, historical selection of presentation devices or an end user device which is currently actively in use by a particular end user. Historical presentation device selection data, currently active device data and addresses for each of an end user's end user devices are stored in a data structure discussed below with respect to FIG. 5.

The different scheduling marker data queues can be assigned and distributed to end user devices based on correlation between future video event categories (sports, politics, etc.) end user profile data according to the data type, viewing history, program type, area of interest, geographic region, demographic (location, age, language, income, gender, purchase history, etc.) and according to a tendency to respond to a particular data type of an end user or an end user's demographic. Each end user's historical response to a particular data type is recorded and stored at the end user device. A tendency for each end user to respond to a particular data type is determined from the recorded responses and used to determine a tendency of an end user to respond to the data type. Weights are assigned to data types based on the user's response tendency each data type (image, video, audio, text). These tendencies are reported to the IPTV system servers for use by advertisers in directing future video event scheduling data and scheduling marker data queues to particular end users and the end users' demographic groups.

Weighting data for each end user and each end user demographic group can be stored at the IPTV server and used to weight scheduling marker data queues to demographic groups of end users and individual end users. Additional criteria stored in an end user profile, including but not limited to Internet purchasing history, internet surfing activity, etc. can be used to weight scheduling data and scheduling marker data queue elements. Scheduling data elements in the queue are weighted more heavily and favored over data with less weight. Historical viewing habits for an end user are stored in the end user profile along with purchase history, demographic data, location, income, etc. and used by advertisers in selecting which programs advertised as future video events and which end users receive a scheduling marker for the future video event in their scheduling marker data queue. In one particular illustrative embodiment, a scheduling marker data queue includes but is not limited to a list of one or more scheduling markers (also referred to herein as “queue elements” or “elements”).

In a particular illustrative embodiment the weighting data that may be included is a set of weights assigning data type weights, response tendency weights, viewer profile weight, future video event category, and/or regional weights. In another particular embodiment the weighting data includes weighted reference data, which is used to favor selection of scheduling marker data and scheduling data sensed by the EUDSS or UDSS. Thus the weighted marker data will be favored or weighted more heavily than other alternative data. For example if a particular end user or a demographic for a particular end user has a tendency to respond more to text data than audio data, then sensed marker text data will be weighted more heavily than sensed marker audio data. Regional weighted marker data can be sent to favor different scheduling marker data in different regions. Thus the same marker data queue can be sent to different regions and the weighting data can be used to favor different scheduling marker data queue elements in different regions. Thus, weighting can be used to select a top five out of ten scheduling queue elements for future video events to be selected in each region, which may vary by region. In another alternative embodiment, the weighting data can be altered by an end user profile. In another illustrative embodiment, different alternative data can be sent to different regions or different end users. In a particular illustrative embodiment, the same scheduling data queue can be sent to 3 end users but different weighting data can be sent to each end user to that each end user selects a different top five out of ten scheduling queue element for sensing and display of schedulable video events.

Similarly, if an end user is in a particular demographic group with a known response to particular data types or a particular end user has a tendency to respond more to video or image data than text data, then marker and scheduling data for the sensed scheduling and marker video or image data will be weighted more heavily than sensed text data for the particular end user or demographic group of end users. In another particular illustrative embodiment, each end user device receives the same list of scheduling marker queue data and a different list of alternative data based on their end user profile. The alternative data may include names of businesses near the end user device location, names of foods or celebrities that appeal to a demographic group with which the end user is associated based on the data stored in the end user profile stating location and demographic group for the end user.

Scheduling and marker data can be supplied to the UDSS 103 or the EUDSS 106 by an advertising server 152 from the IPTV system general database 103 or by an advertiser reference data database 102. The scheduling data and marker data queues can contain video data, image data, audio data, text data, and advertising data, which can be used for replacement of scheduling of future video event data for presentation on an end user device. The scheduling data can also be marked by the UDSS so that less processing power is required to sense scheduling data at the EUDSS, since the EUDSS would only have to look for scheduling data and scheduling markers data (video, audio, text, image) rather that performing full sensing (video, audio, text, image) including but not limited to speech recognition, pattern recognition, and image recognition.

The advertiser or user can select regions, data types and demographics by selecting weighting data or scheduling maker queue data for insertion into the television signal or downloading to an end user device from the IPTV network SHO, VHO or CO. Each generic and alternative data item can have a particular weight assigned in the database and can be used to weight scheduling data. Keywords for text, image, video and audio scheduling data comprise image or video data such as audio or text phrases associated with scheduling data in a data base or a video stream can be weighted by the weighting data for selecting and prioritizing a scheduling marker data queue.

In an illustrative embodiment the data sensing devices (UDSS and EUDSS) sense or recognize scheduling marker data in the video data stream. The sensed scheduling data can be replaced at the IPTV server with scheduling markers data and sent to the EUDSS where the scheduling marker data are associated with appropriate scheduling data for a future video event. The scheduling marker data can be used as an index into the database 150 for associating the marker with a particular scheduling data seta. The audio and text passages of scheduling data include text and audio key words that are identified using speech recognition and text recognition techniques. A default weighting data for data type weight is assigned on a scale of 10, for audio data=7, video/image data=5, and text data=3. A default weighting data for event category weight is assigned on a scale of 10, for sports data=7, politics data=5, and fashion data=3. Those weights can be adjusted by weighting the reference data downloaded to the end user device. Additional weight is assigned to keywords (e.g., football, Corvette, Wild at Heart) in the same category (e.g., sports, politics, cars, movies, etc.) appearing in more than one data type at substantially the same time (e.g., within 2 seconds). Thus if the image of a football and the phase “football team” which are in the same category, i.e., sports, are sensed in the television signal at the same or close to the same time, additional weight is assigned to the generic phrase “football team.”

The keywords can also be weighted by the context, which includes time of day, geographic region and current viewer profile, response tendency, demographic, which is provided by system 110. Thus the key word data (audio, image, text or video) for “foot ball team”, i.e., “Dallas Cowboys” can be assigned more weight in Texas than Washington, D.C. A different alternative data item for football team, i.e., “Washington Redskins” can be assigned more weight in Washington, D.C. The keywords, which are weighted according to the inputs in block 108, are sent to system 112 where the alternative data are weighted.

In an illustrative embodiment the EUDSS 106 receives input from an end user remote control 133 to schedule future video events and notifications of pending delivery and presentation of future video event data. The EUDSS also senses reference data in the stored advertising data. The key words include image, text, audio and video data. A context is recorded in system function block 110 wherein the processor records time of day, viewer profile, programs viewed, and region associated with the selected advertising data.

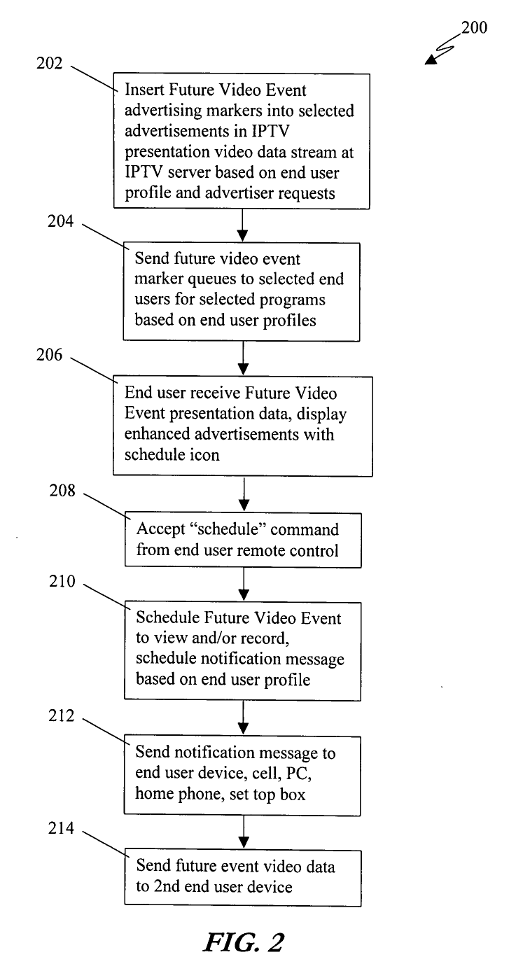

Turning now to FIG. 2 in an illustrative embodiment a series of functions performed by a software agent or component executed by an illustrative system processor are performed to schedule notification, receipt and presentation of future video events data. As shown in FIG. 2, in an illustrative embodiment enhanced advertising markers data are inserted into selected advertisements in an IPTV video data stream at an IPTV server based on end user profile and advertiser request at block 202. Future video event scheduling marker data queues of marker or elements are sent to end users for selected programs based on end user profiles at block 204. Display video data are received, wherein enhanced advertisements are displayed with an icon at block 206. A “schedule” command is accepted from an end user remote control at block 208. A future video event is scheduled to view and/or record, schedule notification message based on an end user profile at block 210. Notification message data is sent to end user cell, PC, and home phone at block 212. Future event data is displayed at a selected end user device at block 214.

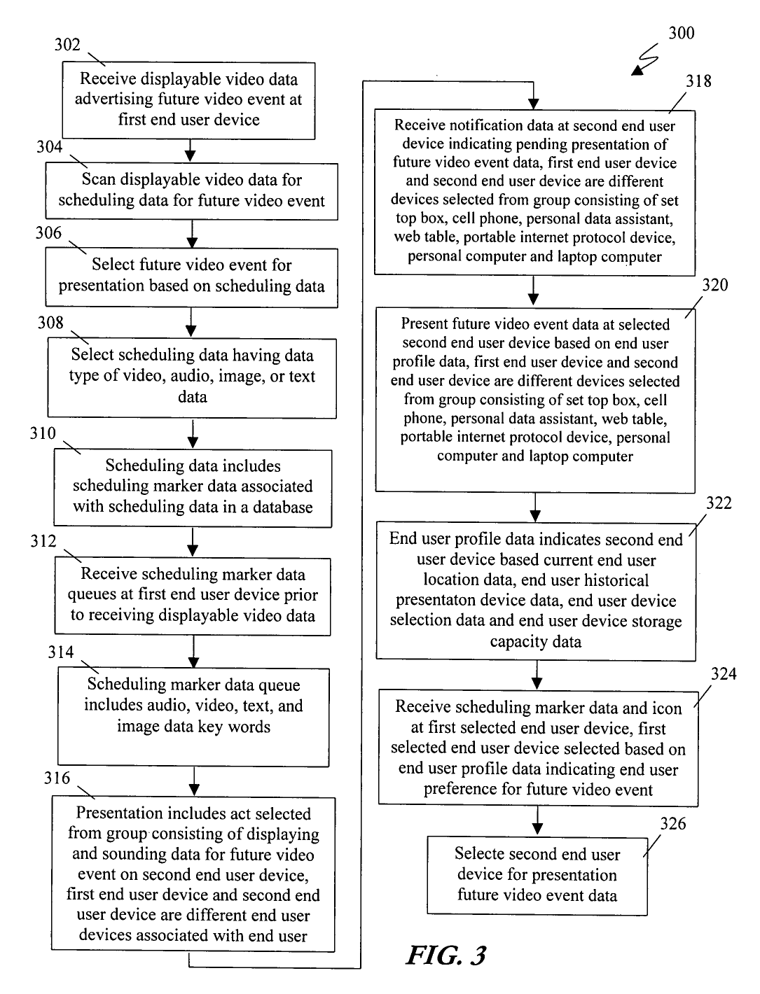

Turning now to FIG. 3, in an illustrative embodiment displayable video data containing displayable scheduling data advertising future video events is received at a first end user device at block 302. The displayable video data is scanned for scheduling data for future video events at block 304. When an end user schedules a future video event, that is, selects the future video event for presentation, the future video event is queued for presentation based on scheduling data for the future video event at block 306. A future video event scheduling icon is displayed when an end user device senses scheduling data associated with the future video event. Scheduling data is selected from the group consisting of video, audio, image, and text data at block 308. Scheduling data includes scheduling marker data associated with scheduling data in a database at block 310. Scheduling marker data is received at a first end user device prior to receiving displayable video data at block 312. Scheduling marker data includes keyword data selected from the group consisting of audio, video, text, and image data at block 314. Presentation includes but is not limited to displaying and sounding data for future video event on a second end user device. In a particular illustrative embodiment, the first end user device and second end user device are different end user devices associated with an end user as shown at block 316.

Notification data is received at a second end user device indicating pending receipt of future video event data. The first end user device and second end user device are different devices selected from the group consisting of a set top box, cell phone, personal data assistant, web tablet, portable internet protocol device, personal computer and laptop computer at block 318. Future video event data is presented at a selected second end user device wherein selected second end user device selected based on end user profile data wherein first end user device and second end user device are different devices selected from the group consisting of a set top box, cell phone, personal data assistant, web tablet, portable internet protocol device, personal computer and laptop computer at block 320. End user profile data indicates second end user device based on a factor selected from the group consisting of end user location data, end user historical viewing history data, end user device selection data and end user device storage capacity data at block 322. Scheduling marker data queues are received by a first selected end user device. The first selected end user device is selected based on end user profile data indicating end user preference for future video event at block 324. A second end user device is selected for presentation of data for future video event at block 326.

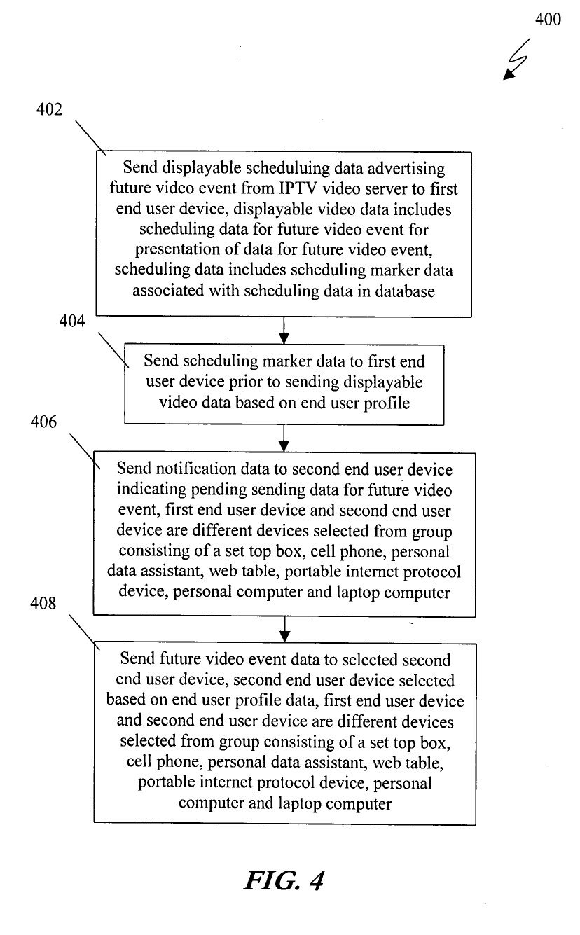

Turning now to FIG. 4, in an illustrative embodiment displayable video data for advertising a future video event is sent from an IPTV video server to first end user device wherein displayable video data includes scheduling data for future video event for presentation of data for future video event wherein scheduling data includes scheduling marker data associated with scheduling data in database at block 402. Scheduling marker data is sent to a first end user device prior to sending displayable video scheduling data based on an end user profile at block 404. Notification data is sent to a second end user device indicating pending sending data for future video event wherein first end user device and second end user device are different devices selected from the group consisting of a set top box, cell phone, personal data assistant, web tablet, portable internet protocol device, personal computer and laptop computer at block 406. Future video event data for a scheduled future video event is sent to a selected second end user device wherein the selected second end user device is selected based on end user profile data wherein first end user device and second end user device are different devices selected from the group consisting of a set top box, cell phone, personal data assistant, web tablet, portable internet protocol device, personal computer and laptop computer at block 408.

Turning now to FIG. 5, in a particular illustrative embodiment a data structure 500 embedded in a computer readable medium for providing a structural and functional interrelationship between the data in the data structure and a processor, processor software or method for presenting data related to an end user profile data. The data structure 500 includes fields for storing data used by an illustrative embodiment of a system and method. In data structure field 502 an end user profile data field is illustrated for storing data indicative of end user profile data. In data structure field 504 an end user historical presentation device data field is illustrated for storing data indicative of end user historical presentation device data. In data structure field 506 a video scheduling marker data field is illustrated for storing data indicative of video scheduling marker data. In data structure field 508, an end user device addresses field is illustrated for storing data indicative of end user device addresses.

In data structure field 510, an end user device formats field is illustrated for storing data indicative of end user device formats. When an end user device is sent data, the data may be formatted according to the field 510. In data structure field 512, an end user device selection for presentation field is illustrated for storing data indicative of end user device selection for presentation. In data structure field 514, an end user device selection for notification field is illustrated for storing data indicative of end user device selection for notification. In data structure field 516 a current end user device active for notification data receipt field is illustrated for storing data indicative of end user device active for notification data receipt. In data structure field 518 a future selected enabled icon field is illustrated for storing data indicative of future selected enabled icon.

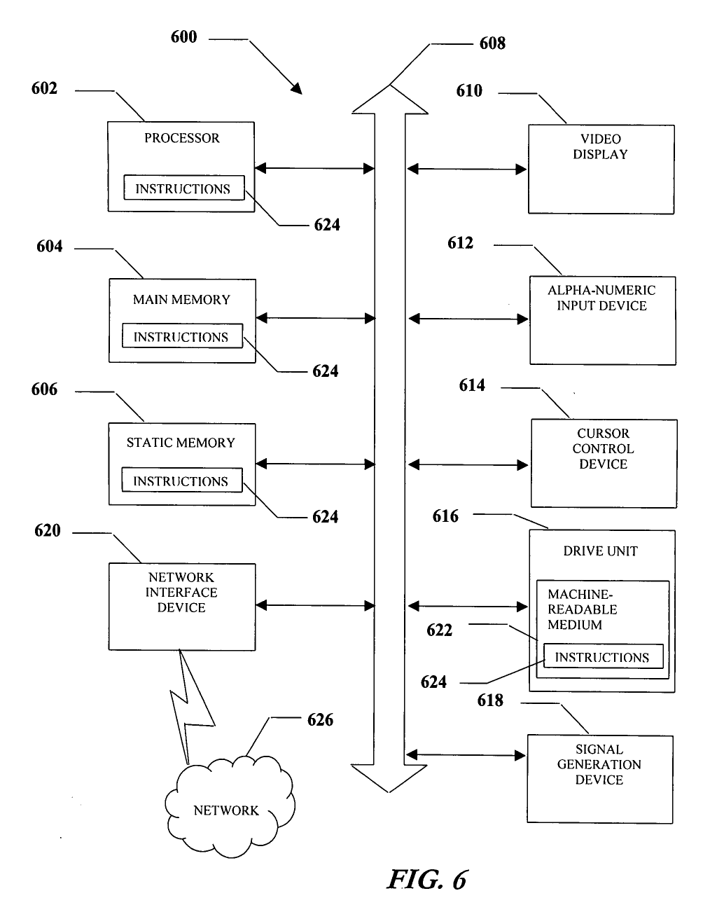

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620. The machine readable medium may also contain a data structure for containing data useful in providing a functional relationship between the data and a machine or computer in an illustrative embodiment of the disclosed system and method.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for presenting video data comprising:
receiving at a first end user device, displayable video data for advertising a future video event;
scanning the displayable video data for scheduling data associated with the future video event; and
queuing the future video event for presenting data for the future video event based on the scheduling data.

2. The method of claim 1, wherein the scheduling data are data selected from the group consisting of video, audio, image and text data.

3. The method of claim 1, wherein the scheduling data further comprises scheduling marker data associated with preloaded scheduling data in a data base.

4. The method of claim 3, wherein the scheduling marker data are received at the first end user device prior to receiving the displayable video data.

5. The method of claim 3, wherein the scheduling marker data further comprise key word data selected from the group consisting of audio, video, text and image data.

6. The method of 1, wherein presenting further comprises an act selected from the group consisting of displaying and sounding data for the future video event on a second end user device, wherein the first end user device and the second end user device are different end user devices associated with an end user.

7. The method of claim 1, further comprising:
receiving notification data at a second end user device indicating pending presenting the of data for the future video event, wherein the first end user device and the second end user device are different devices selected from the group consisting of a set top box, cell phone, personal data assistant, web tablet, portable internet protocol device, personal computer and lap top computer.

8. The method of claim 1, further comprising:
presenting the data for the future video event at a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

9. The method of claim 8, wherein the end user profile data indicates a second end user device based on a factor selected from the group consisting of end user location data, end user historical presenting history data, end user device selection data and end user device storage capacity data.

10. The method of claim 3, wherein the scheduling marker data are received by a first selected end user device, wherein the first selected end user device is selected based on end user profile data indicating an end user preference for the future video event.

11. The method of claim 1, further comprising:
selecting a second end user device for presenting the data for the future video event.

12. A method for sending video data to an end user device, comprising:
sending from a internet protocol television (IPTV) video server to a first end user device, displayable video data for advertising a future video event, wherein the displayable video data includes scheduling data for the future video event for presenting of data for the future video event, wherein the scheduling data further comprises scheduling marker data associated with the scheduling data in a data base.

13. The method of claim 12, wherein the scheduling marker data are sent to the first end user device prior to sending the displayable video data based on end user profile data.

14. The method of claim 12, further comprising:
sending notification data to a second end user device indicating pending data for the future video event, wherein the first end user device and the second end user device are different devices selected from the group consisting of a set top box, cell phone, personal data assistant, web tablet, portable internet protocol device, personal computer and lap top computer.

15. The method of claim 12, further comprising:
sending data for the future video event to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

16. A computer readable medium containing a computer program useful for presenting video data, the computer program comprising:
instructions to receive at a first end user device, displayable video data advertising a future video event;
instructions to scan the displayable video data for scheduling data for the future video event; and
instructions to queue the future video event for presentation based on the scheduling data.

17. A computer readable medium containing a computer program useful for sending video data to an end user device, the computer program comprising:
instructions to send from an internet protocol television (IPTV) video server to a first end user device, displayable video data advertising a future video event, wherein the displayable video data includes scheduling data for the future video event for presenting data for the future video event wherein the scheduling data further comprises scheduling marker data associated with the scheduling data in a data base.

18. The method of claim 17, wherein the scheduling marker data are sent to the first end user device prior to sending the displayable video data based on an end user profile.

19. A system for presenting video data comprising:
a first end user device processor in data communication with a memory, the first end user device processor further comprising a first interface for receiving at a first end user device, displayable video data advertising a future video event;
and
a computer program embedded in the memory, the computer program comprising instructions to scan the displayable video data for scheduling data for the future video event and instructions to queue the future video event for presentation based on the scheduling data.

20. The system of claim 19, the processor further comprising:
a second interface for receiving scheduling marker data associated with the scheduling data in a data base, wherein the scheduling marker data further comprise key word data selected from the group consisting of audio, video, text and image data.

21. The system of claim 19, further comprising:
a second end user device processor in data communication with a memory, the second end user device processor comprising:
a third interface for receiving notification data for the future video event.

22. The system of claim 19, further comprising:
a second end user device processor in data communication with a memory, the second end user device processor comprising:
a fourth interface for receiving data for the future video event.

23. A system for sending video data to an end user device, comprising:
a processor at a video server in data communication with a memory, the processor further comprising:
a first interface for sending from the video server to a first end user device, displayable video data advertising a future video event, wherein the displayable video data includes scheduling data for the future video event for presentation of data for the future video event, wherein the scheduling data further comprises scheduling marker data associated with the scheduling data in a data base.

24. The system of claim 23, wherein the scheduling marker data are sent to the first end user device prior to sending the displayable video data based on an end user profile.

25. The system of claim 23, further comprising:
a second interface for sending notification data to a second end user device indicating pending data for the future video event, wherein the first end user device and the second end user device are different devices selected from the group consisting of a set top box, cell phone, personal data assistant, web tablet, portable internet protocol device, personal computer and lap top computer.

26. The system of claim 23, further comprising:
a third interface for sending data for the future video event to a selected second end user device, wherein the selected second end use device is selected based on end user profile data wherein the first end user device and the second end user device are different devices selected from the group consisting of a set top box, cell phone, personal data assistant, web tablet, portable internet protocol device, personal computer and lap top computer.

27. A computer readable medium having a data structure embedded therein for storing data, the data structure further comprising:
a first field for containing data indicating displayable scheduling marker data for a future video event selected based on end user profile data.

28. The medium of claim 27, the data structure further comprising:
a second field for containing data indicating an end user device presentation selection for selecting an end user device for receiving data for the future video event.

29. The medium of claim 27, the data structure further comprising:
a third field for containing data indicating an end user device notification selection for selecting an end user device for receiving notification data regarding scheduling of the future video event.

30. The medium of claim 27, the data structure further comprising:
a fourth field for containing data indicating an end user device storage capacity for an end user device for determining whether the end user device can store data for the future video event.
